(19) United States
(12) Patent Application Publication
(10) Pub. No.: US 2015/0221149 A1
(43) Pub. Date: Aug. 6, 2015

(54) WIFI WALLET PAYMENTS AND ENTRY KEYS

(71) Applicants: Richard Brewster Main, Newark, CA (US); Akli Adjaoute, Mill Valley, CA (US)

(72) Inventors: Richard Brewster Main, Newark, CA (US); Akli Adjaoute, Mill Valley, CA (US)

(21) Appl. No.: 14/683,148

(22) Filed: Apr. 10, 2015

Related U.S. Application Data
(60) Provisional application No. 62/019,372, filed on Jun. 30, 2014.
(60) Provisional application No. 62/029,480, filed on Jul. 26, 2014.

(51) Int. Cl. G07C 9/00; H04W 48/16; H04W 12/06

(52) U.S. Cl. CPC G07C 9/00119; H04W 12/06; H04W 48/16; H04W 84/12

(57) ABSTRACT

A WiFi Wallet includes an app that installs on a smartphone or other mobile device having a wireless local area network connection manager and mobile telephone network access. Local preexisting wireless access points and routers are adjusted to transmit type (R)SSID service set identifiers in their beacons and to invite brand-named guest network logons. The WiFi wallet app is provisioned with a matching password for the (R)SSID that will gain it Internet access. Once on the Internet, the WiFi wallet app logs onto a network server to deposit an encrypted cardholder token. A location identifier for the particular local wireless access points and router naturally tags on. The network server generates an anonymous WiFi Wallet token and sends it to the user over mobile telephone network and the host location over secure Internet. At checkout, lock-open, or secure log-in, the user displays their token to the host location security barrier.

### BACKGROUND OF THE INVENTION

1. Field of the Invention

The present invention relates to authentication-boosting wireless routers, and more particularly to a sequenced (1) wireless handshaking between user mobile devices and the local wireless environments while they visit, (2) registering the visit on a network server, and (3) authenticating from the network server the users through their mobile devices to a single local point-of-sale terminal, system administrator console, or security access lock.

2. Background

Security checkpoints cannot trust any credential a stranger hands them as authentication of them or access authorization. Security at checkpoints can be improved if the credentials presented are verified by a secure remote server. Old time banks did that years ago when a stranger presented a large check to be cashed at the counter. The bank clerk would check the account for funds and sometimes even call the accountholder and ask did they really write this check.

The ubiquity of wireless routers and access points allows all of us to authenticate and authorize everywhere, with everyone, for every security purpose today. In the United States, just about everybody out in public has a smartphone in their hands poking away at it or ready to take calls and messages in their pockets. And everywhere you go there are WiFi hotspots broadcasting their SSID's wanting passwords. Home, work, business, shopping malls, school, government offices, hospitals, clinics, travel centers, airlines, buses, and even McDonalds. (Most are secured and not guest networks.)

### SUMMARY OF THE INVENTION

Briefly, WiFi Wallet Payment and Access Key embodiments of the present invention automatically scan for authentication-boosted wireless routers everywhere they visit while in the pockets of users. A simple mobile app provides a sequenced (1) wireless handshaking between the user mobile device and the local wireless environment during their visit, (2) the app registers the new visit on a network server, and (3) the network server authenticates the users through their mobile devices to a single local point-of-sale terminal, system administrator console, or security access lock. Sensitive financial and personal information never leaves the network server.

Each WiFi Wallet provides a universal key for its single user to make payments and access secure facilities with the same mobile device. Specific pieces of equipment can be assigned to particular employees for an explicit time. Facilities can simultaneously manage different access levels, as well as secure from unwanted visitors. Special types of access control can be programmed to open during a window-of-time. Migrating security badges and access keys into mobile devices reduces costs and delays in issuing them, and increases the inherent security, all without physically delivering a card. The server can monitor every access in real-time and manage attendance up-to-the-minute. The server can trigger alarms if a high security place loses its protection. Alerts can be triggered if an insufficiently authorized person is trying to gain access to a more restricted area.

Briefly, a wrist worn authenticator embodiment of the present invention chirps out an encrypted authentication burst packet when the device is tapped by a finger on the other hand. The chirps are output as audio chirps, IR-LED chirps, and/or wireless chirps. All of which can be sensed by a smartphone or tablet equipped with a WiFi Wallet app. The chirps are encrypted with device-ID, GPS location, local time, and user biometrics. A display normally shows the user the time-of-day, and will annunciate any local authentication requests it senses. The device collects biometric data available to it by direct contact and passes it on by embedding it in the chirps, without trying to locally authenticate the collected biometrics to the present user. User authentication occurs in the Cloud, with further qualifications of time, place, device-ID, user behavior, and registration constraints. Direct contact biometric data collection includes pulse, venous patterns, fingerprint, gestures, continuous wear, and temperature. Strong multi-factor authentications combine from who-you-are, what-you-have, where-you-are, how-you-behave, and what-time-it-is.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a functional block diagrams illustrating a secure access system for users with mobile devices, in an embodiment of the present invention;

FIGS. 2A-2F are functional block diagrams of a WiFi Wallet environment that includes the cardholder's mobile client equipped with a WiFi Wallet app, a merchant with a guest wireless access point and point of sale device, and a website hosted by a payment network. FIGS. 2B-2F represent the sequence of exchanges that occur as a WiFi Wallet user moves about and makes a purchase;

FIGS. 3A and 3B are a functional block diagram and a flowchart showing how a WiFi Wallet Shopping Token can be accepted by a merchant equipped only to deal with magnetic stripe cards and how the merchant acquirer can process the transaction in a conventional way;

FIG. 4 is a flowchart diagram of the interplay between the WiFi Wallet mobile client, a merchant, and the merchant acquirer;

FIG. 5 is a diagram representing merchant equipped only with a conventional magnetic stripe card reader, and how the merchant acquirer can be signaled by the keypad entries to process the transaction in a conventional way;

FIG. 6 is a diagram of a wrist-worn authenticator useful in completing or authenticating a transaction by a WiFi Wallet user;

FIG. 7 is a software flowchart of one starting piece of the program software flow for a typical WiFi Wallet app. A connection manager begins with a search for any wireless routers broadcasting service set identifier (SSID) beacons within range;

FIG. 8 is a software flowchart of the runtime software interplay between a home wireless access point and a payment network's (R)SSID website;

FIG. 9 is a software flowchart of the runtime software interplay between a merchant's wireless access point and a payment network's (R)SSID website;

FIG. 10 is a functional block diagram of WiFi Wallet Peer-to-Peer (P2P) application in an embodiment of the present invention; and

FIG. 11 is a functional block diagram of a smart-agent based adaptive method for mobile payments fraud detection in an embodiment of the present invention useful in the devices and methods described in the previous drawings.

### DETAILED DESCRIPTION OF THE INVENTION

WiFi Wallet embodiments of the present invention enable cardholding consumers to communicate with their issuing bank in real time by their own independent, secure back channel. For example, by their mobile network number or 4G/LTE mobile device access to their email account.

American consumers are OK with handing over a payment card, swiping it, checking the total, entering a PIN or signature if all is correct, and putting the payment card back in their wallet. Asking the American consumer to do any more than that will pave the Road to Failure.

At checkout, embodiments of the present invention ask the consumer to tell the merchant the temporary shopping ID then automatically displaying already on their mobile device. A few seconds later their issuing bank will send them a secure message about the transaction, and ask do they approve. If they do, the consumer keys in a PIN or password on their mobile device, and the merchant gets word through their merchant bank acquirer to release the purchase. The merchant never does get any sensitive data, what they do get is all they care about. They got paid.

Therefore, all the merchants need to add to their operations will be a way to key in or receive the temporary shopping ID the consumer gives them at checkout. Online this addition will be trivial. In-store, some new programming of the POS terminal or a preexisting magnetic card reader may be needed. Full, one-time-use 16-digit payment card numbers could be used, but better to use a short alpha numeric.

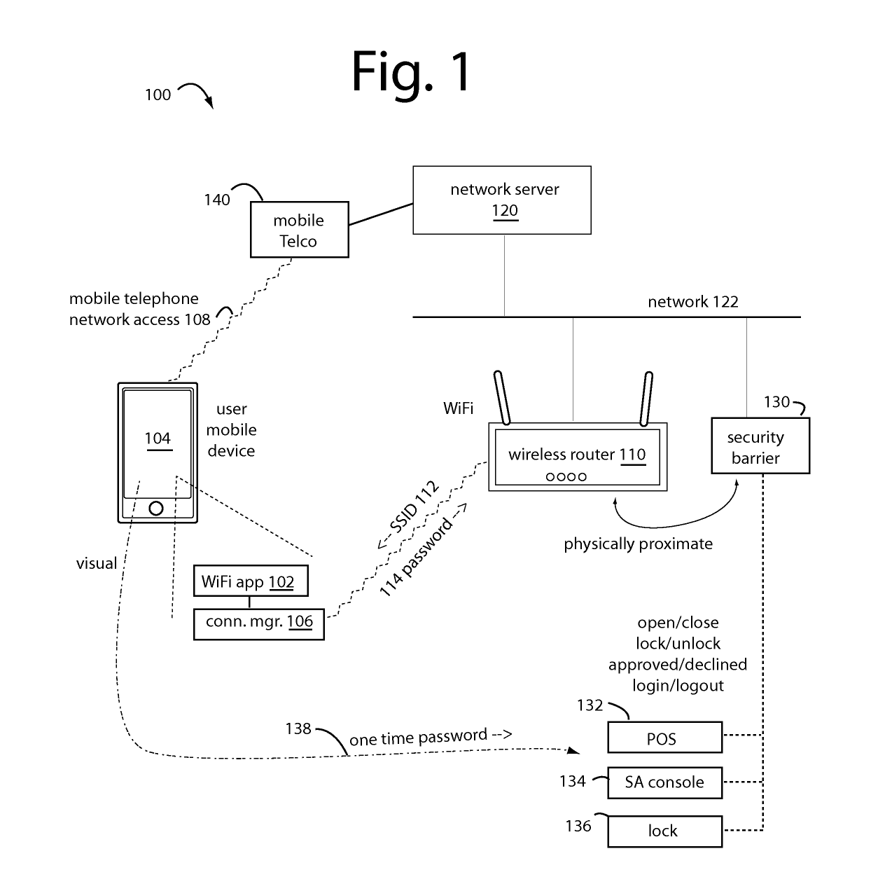

FIG. 1 represents a secure access system for users with mobile devices, in an embodiment of the present invention referred to herein by the general reference numeral 100. Secure access 100 includes a mobile app data structure 102 for installation in a user mobile device 104 with a wireless local area network connection manager 106 and mobile telephone network access 108. A wireless access point 110 is adapted to broadcast a particular SSID 112 in a beacon that will accept a predetermined password 114 from any locally visiting user mobile device 104. The mobile app data structure 102 includes training data to allow the user mobile device 104 to search for the particular SSID 112 and to automatically supply the predetermined password 114. For example, the SSID 112 could transmit “MASTERCARD™” as an invitation for shoppers to pay for purchases with their MasterCard accounts. Some wireless access point 110 can be set not to broadcast their working SSID's. That may be desirable in security areas with cleared individuals. The passwords 114 in these cases would be tightly held and not published.

A network server 120 is accessible over a network 122 by the wireless access point 110 and the user mobile device 104 once logged onto the wireless access point 110. A security barrier 130 is physically proximate to the wireless access point 110, and provides at least one of payment transaction security to a point-of-sale (POS) terminal 132, log-on security for a system administrator's computer console 134, or physical access security to a door or gate lock 136. Each of these require the entry of a one-time-password 138 to complete access.

The one-time-password 138 would be provided after user authentication by network server 120 to visiting user mobile device 104 though a mobile service telephone company 140. The mobile service telephone company 140 provides one way for the network server 120 to independently communicate secure authentication and authorization messages directly with the user mobile device 104 apart from the wireless access point 110. Security barrier 130 takes instructions only from network server 120 on what one-time-passwords 138 to accept and when.

Network server 120 provides for limiting access, e.g., time, place, purpose, or thing after the network server 120 authenticates the user mobile device 104 and authorizes the security barrier 130 to allow local access. Familiar user instructions available to the Public enable them to adjust their wireless access points 110 to broadcast an SSID of their choosing and to accept a particular password. That SSID here is set to a corresponding commercial brand name and published password that company gives to its customers with their downloads of mobile app data structure 102.

Limiting the communication between any locally visiting user mobile device 104 to the network server 120 through the wireless access point 110 to no more than the supplying of a user identity token in an encrypted message reduces the window of opportunity to a fraudster to stowaway. Such limits are built into each mobile app data structure 102. Network server 120 too can shut down access when it gets the user identity token in a correctly encrypted message. If any user mobile device 104 were to present locally to two or more wireless access points at the same time, or present with too brief a time from one to the next in a velocity measure, something is seriously wrong. Enough for network server 120 to un-enroll the offending mobile app data structure 102. The implementation of such would be trivial to an artisan.

WiFi Wallet embodiment of the present invention installed on modern smartphones 104 or other mobile devices can operate seamlessly between short-range, local wireless access point environments at home, work, shopping, and elsewhere.

A long range mobile Telco 140 or other cellular phone service can be expected to support 3G, 4G, and LTE type data communications. In most areas, conventional mobile phone provider networks are able to span local wireless access point environments 110 wherever they are in the world. Each WiFi Wallet app 102 and smartphone 104 has access to a “front” communications channel through the local wireless access point environments, and a private “back channel” through mobile Telco 140.

Each environment at home-work-shopping is equipped with a wireless router or access point 110, respectively. Such wireless router or access points are more or less conventional and manufactured in the millions and already installed around the world by Cisco and others. These wireless router or access points can provide reliable Internet access for devices local to them to the broadband Internet 122. Most logons require authorized users to choose a broadcast channel and provide a password or passphrase. Most devices today will continue to log on automatically without user intervention or help, after the first time the right password is accepted. Strangers and other visitors are generally locked out unless they can get the right password somehow.

A conventional card issuer and merchant bank or acquirer are accessible on the network 122 to cardholders with WiFi Wallet app 102. Businesses, retailers, agencies of all sorts, and merchants of all types are all able to install, operate, or adapt a wireless router or access point 110.

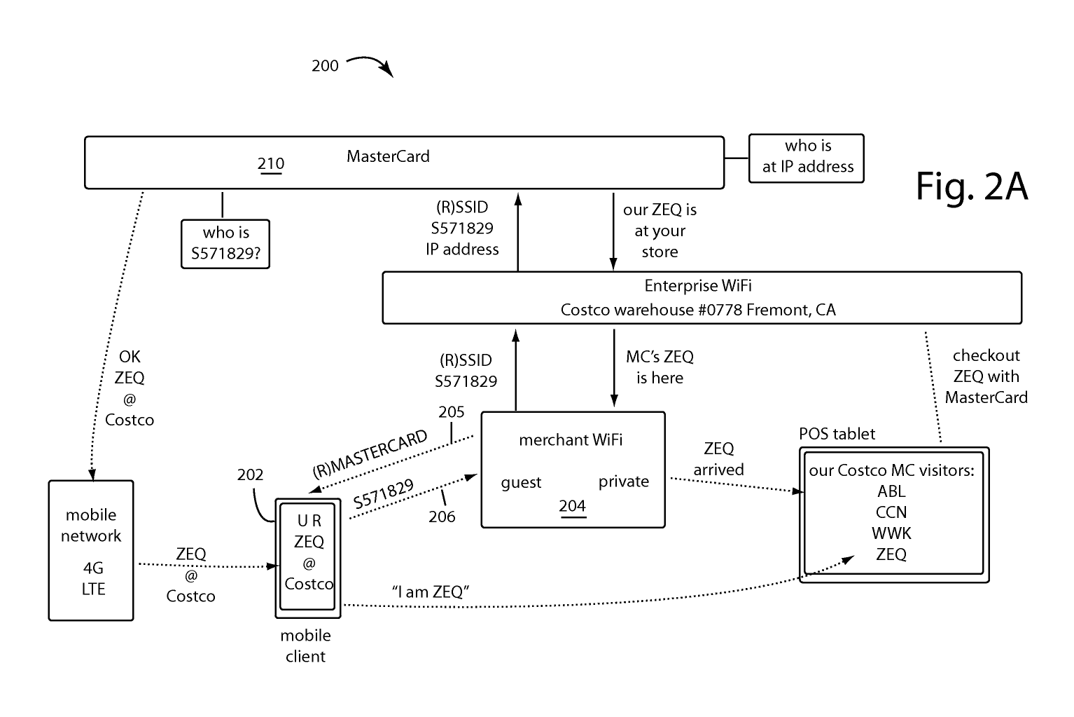

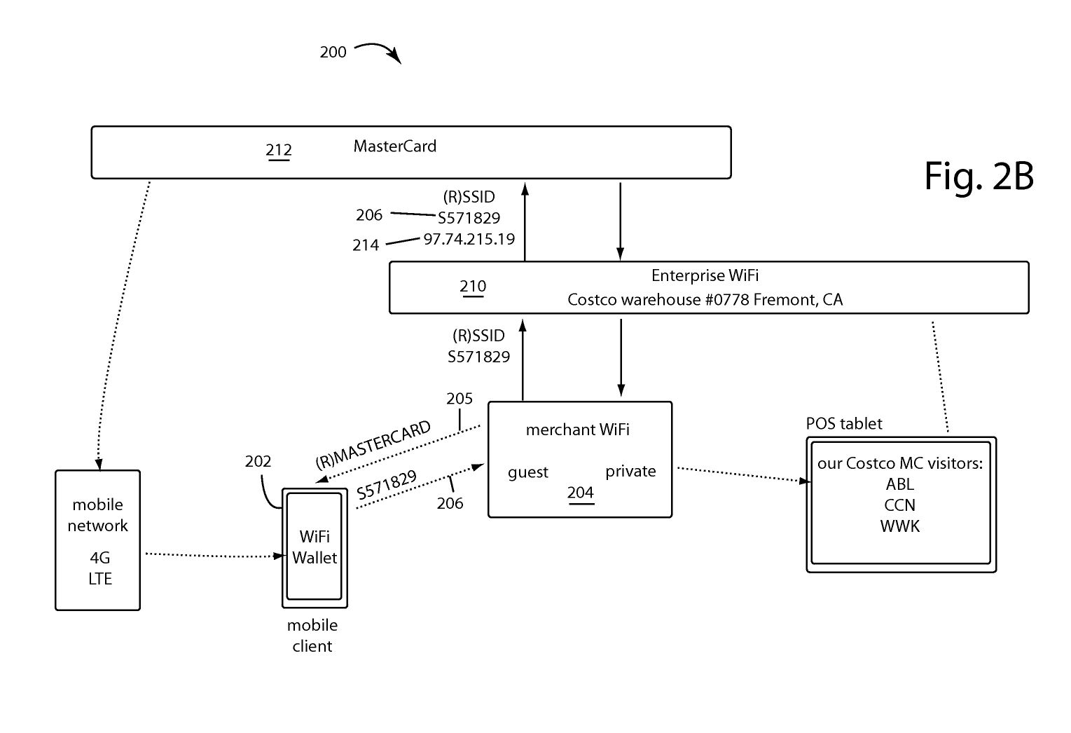

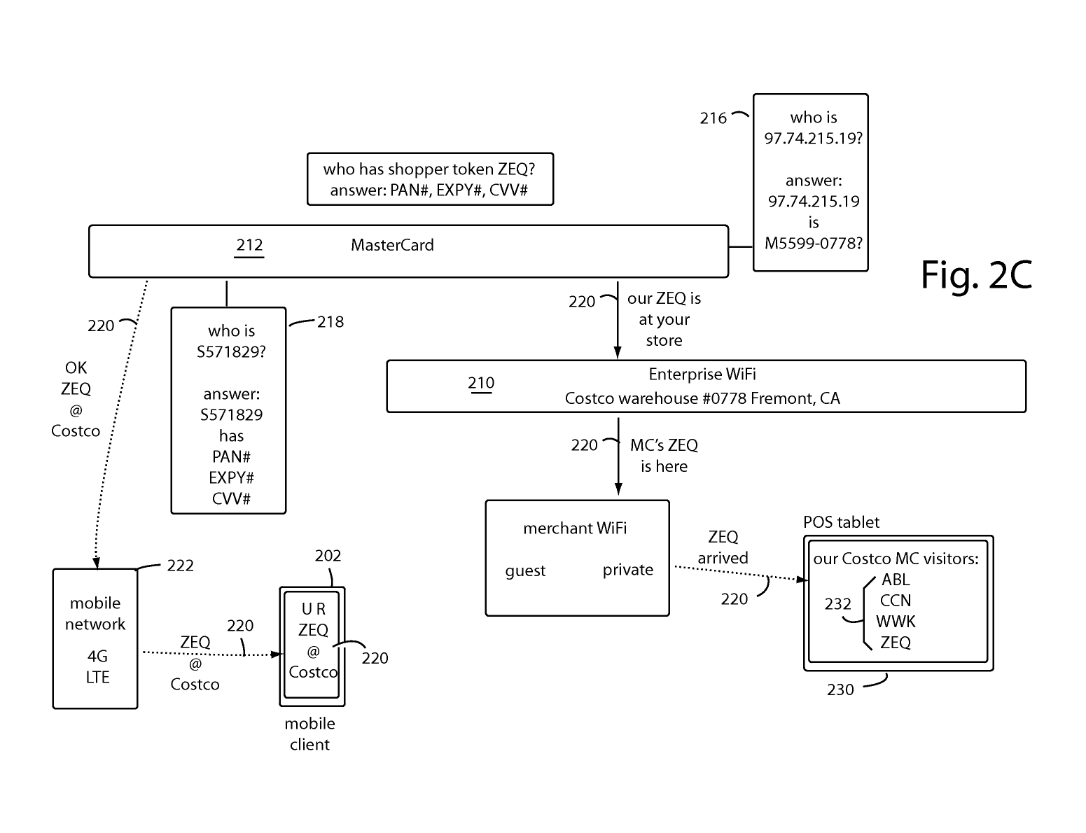

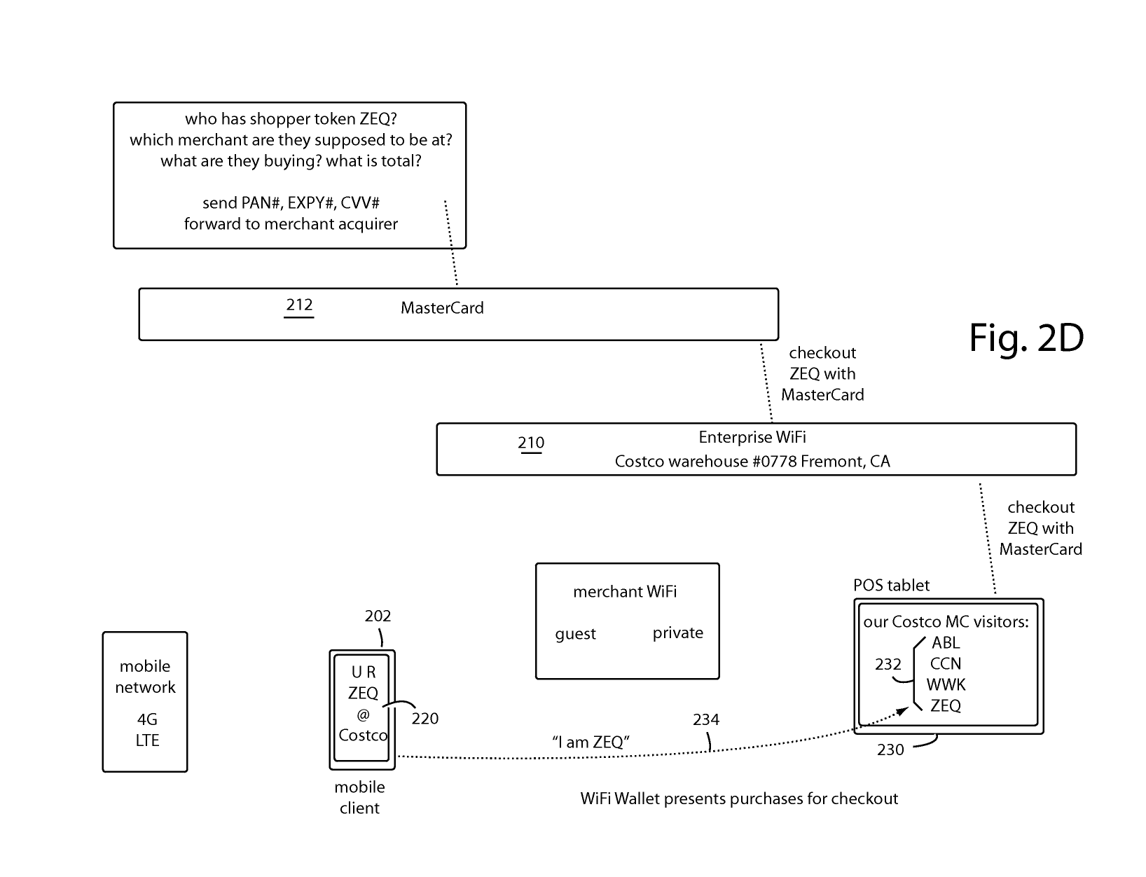

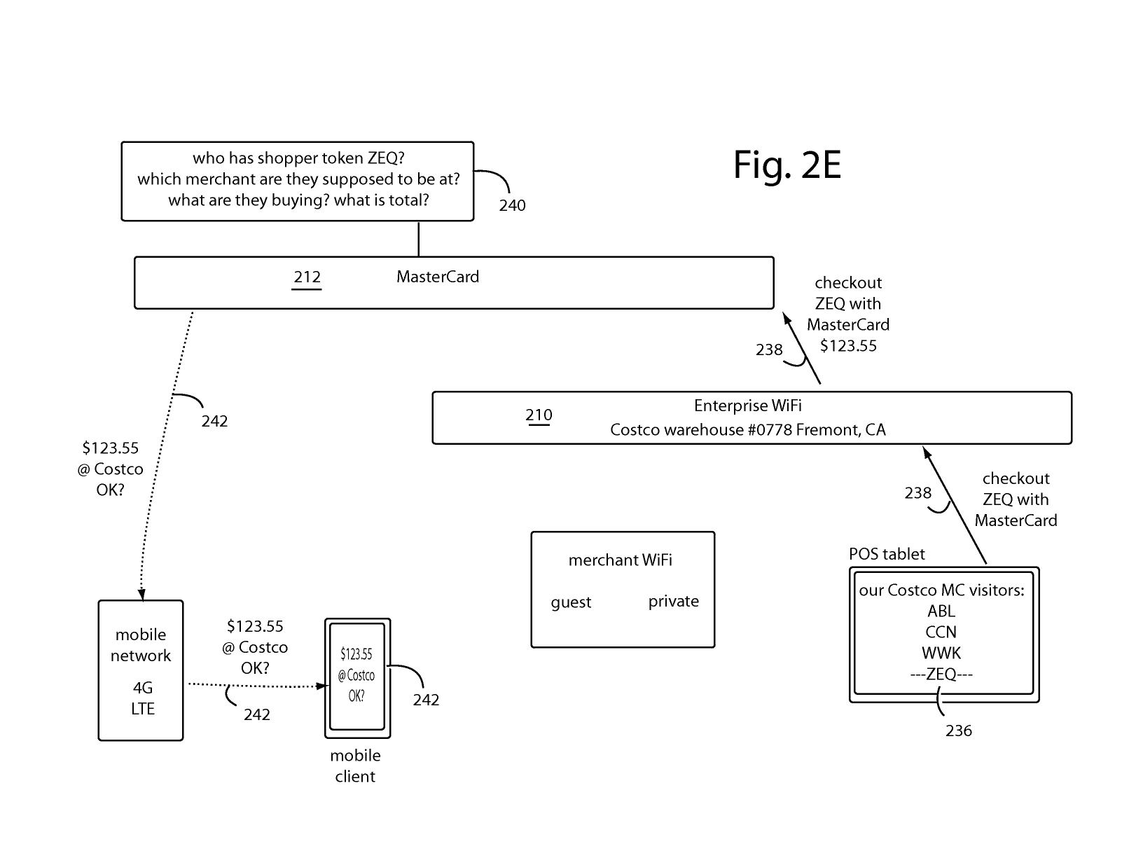

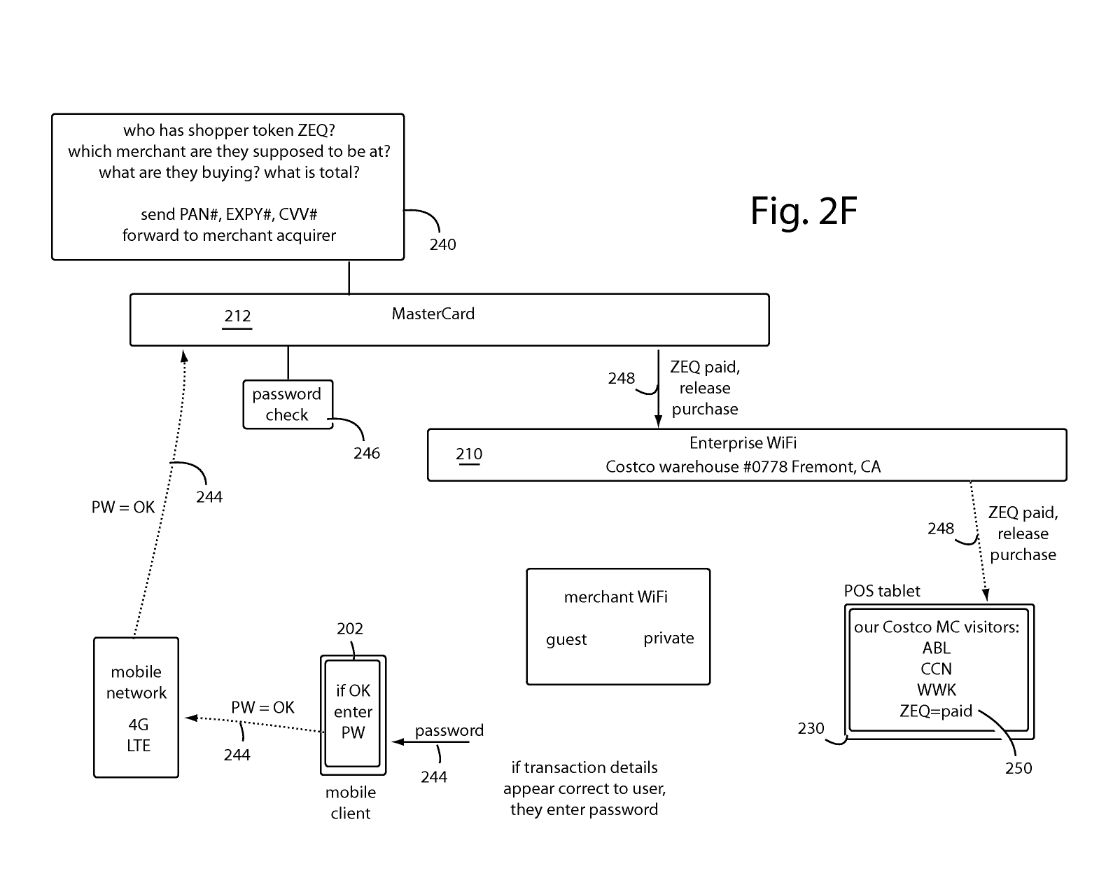

FIGS. 2A-2F represent an operational WiFi Wallet network 200 in which a WiFi Wallet app has been installed on a mobile client (smartphone) 202 and is carried by a typical cardholder, e.g., a MasterCard customer. Every merchant, like Costco who we use here as a familiar example, with a WiFi access point 204 and who accepts MasterCard, for example, broadcasts an identical type “(R)SSID” beacon 205 as guest network, e.g., “®MASTERCARD”.

Every such merchant WiFi access point 204 is universally setup to accept the same password or passphrase. WiFi Wallet 202 is pre-provisioned with the right passwords to use.

Arranging for every WiFi access point to require a corresponding password for each (R)SSID password prevents accidental logons that could occur if no password at all was required. Each merchant WiFi access point 204 is required also, for example, to use WPA2-personal-AES security.

FIG. 2B represents a next step in a sequence for WiFi Wallet network 200. Worldwide, such steps would occur billions of times at millions of WiFi access points 204.

Once logged onto WiFi access point 204, WiFi Wallet 202 will have Internet access through an enterprise router 210. It uses a uniform resource locator (URL) it was pre-provisioned with to logon to an Internet website operated by MasterCard 212.

The MasterCard website 212 will need a user ID to go further. WiFi Wallet 202 sends out a device ID or MasterCard subscriber number 206, e.g., “S571829”, that was assigned to it, e.g., by our example MasterCard or other issuing bank 212, during registration. If a recognizable user ID or a wrong one is attempted, the session is rejected.

WiFi Wallet 202 logons from mobile devices to the MasterCard website 212 through a merchant WiFi guest network 205 are required to be brief and will be terminated quickly. All that the MasterCard website 212 accepts or needs in this connection is the anonymous WiFi Wallet user ID 206 for the MasterCard subscriber, and the IP address 214 (e.g., “97.74.215.19”) for the particular MasterCard merchant. Every Internet connection automatically provides the source's IP Address, and is hard to spoof.

Fraudsters can play with these all they like without adverse consequences. Identifiers 206 and 214 act as tokens and are only meaningful to the MasterCard website 212.

FIG. 2C represents another step in a sequence for WiFi Wallet network 200. At this level, WiFi Wallet 202 (or a fraudster) has managed to deposit two tokens inside the MasterCard website 212. The user token and the merchant token.

A merchant database 216 is consulted to see who belongs to IP Address “97.74.215.19” in the merchant token. In our example here, we find it was previously registered to Costco warehouse #0778 in Fremont, Calif.

A cardholder database 218 is next consulted to see who belongs to a cardholder token of “S571829”. In our example here, we find it was previously registered to a cardholder with a PAN#, EXPY#, and CVV#. This data will need to be securely forwarded later in the Cloud to the merchant acquirer 118 from issuer 116 (FIGS. 1A-1C).

At this point some security checks can be made, one of the simplest is “can it be possible our cardholder to be in Fremont, Calif., shopping now at Costco?”.

If the cardholder and merchant tokens received checkout with the who is databases 216 and 218, then a temporary, one-time-use WiFi Wallet shopper token 220 can be generated by MasterCard website 212. For example, something brief and easy to remember, “ZEQ”. The WiFi Wallet shopper token 220 is sent privately to the merchant acquirer 118 from issuer 116 (FIGS. 1A-1C), and in a secure Internet message 220 through to a mobile network 222 and ultimately to be displayed on WiFi Wallet mobile client 202. It may be helpful to indicate in such display that MasterCard website 212 thinks the cardholder is shopping in Fremont, Calif., at Costco warehouse #0778.

The WiFi Wallet shopper token 220 is also sent privately to the merchant enterprise WiFi 210 in a secure Internet message and ultimately to be displayed on point-of-sale (POS) terminal or tablet 230. It may be helpful to arrange a list 232 of shopper token in alphanumeric order.

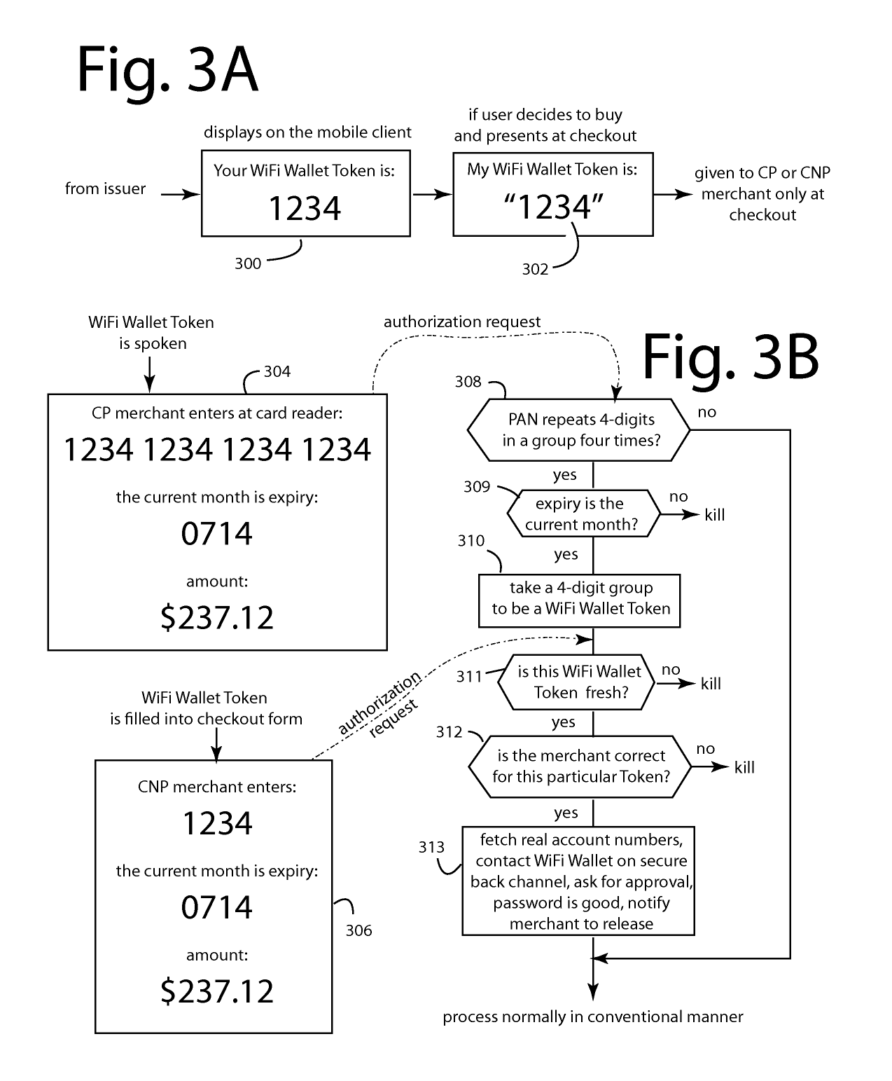

If a previous registration of the merchant has indicated that they are equipped with only a bare minimum of POS equipment, website 212 will issue a four-digit number to serve as WiFi Wallet shopper token 220. See FIGS. 3A and 3B.

FIG. 2D represent what happens if the MasterCard cardholder with WiFi Wallet 202 decides to buy something and presents items for checkout. They speak 234 or otherwise give their WiFi Wallet shopper token 220 to the merchant with POS terminal or tablet 230. The matching “ZEQ” WiFi Wallet shopper token 220 should be available in list 232 for touch selection. If not, the WiFi Wallet shopper token 220 could be bogus and an attempt at fraud. However, the merchant is not required to decide this point.

In FIG. 2E, a touch causes WiFi Wallet shopper token ZEQ to highlight ---ZEQ--- 236. A shopping tally and total 238 are uploaded to website 212 in a request for authorization. A WiFi Wallet shopper token database 240 is consulted to see how to direct an approval request message 242 back through the mobile network to WiFi Wallet mobile client 202. If the approval request message 242 is agreeable to the cardholder, they must then enter their password.

In FIG. 2F, a password 244 is entered on the WiFi Wallet mobile client 202. Such indicates the described transaction and payee are OK, acceptable. Password 244 is carried back over the mobile network. A password check 246 sees if what was returned is correct. If so, WiFi Wallet shopper token database 240 is consulted to provide everything the merchant acquirer 118 requires to complete the transaction. A WiFi Wallet shopper token has paid message 248 is carried down to POS terminal or tablet 230 and given a “paid” marking 250.

Payment card data that is stored, processed, or transmitted must be ordinarily be protected according to PCI Security Standards.

Embodiments of WiFi Wallet 100, 200, 400 do not store, process, or transmit any payment card data out-in-the-wild where merchants and cardholders are interacting. Instead, the issuing banks 116 keep hold of all the payment card data and issue only a sort of record locator token to the WiFi Wallet app. E.g., a “WiFi Wallet User Token” 206, which is nonperishable, meaning it has no fixed expiration time. Such is completely anonymous out-in-the-wild.

Whenever the issuing bank 212 gets a message that includes a WiFi Wallet User Token 206, only the issuing bank has the records needed to fetch the corresponding payment card data and cardholder details. Such WiFi Wallet User Tokens could revolve, mutate, sequence, encode, and otherwise change over time, the only important limitation is that the issuing bank be able to recognize which cardholders payment card data is referenced by it when it comes back in a message.

Airlines issue such record locators to travelers who have electronic tickets. Vehicle license plates are a type of record locator that allows the DMV to know where to look in their records for details about the vehicle registration and its owner. Hotels issue confirmation numbers that allow them to verify an account quickly when a guest presents themselves.

Out-in-the-wild, WiFi Wallet User Tokens 206 must be combined with a Merchant Token 214 that similarly will provide a record locator to a particular merchant 210 and point-of-sale location 204, 230 in the world. These Merchant Tokens 214 too are nonperishable and could simply be the IP address of a merchant's POS device that gets automatically reported whenever the merchant makes a payment request to their acquirer. (See FIGS. 2A-2F)

WiFi Wallet User Tokens 206 are combined with Merchant Tokens 214 automatically whenever a WiFi Wallet app in a mobile clients gets in range of a wireless access point 112, 114, 116, 204, 402, 404, 406. The combination delivers to an issuer's web-presence 212 on the Internet at a URL web address that was predetermined and included in WiFi Wallet app 102. The payload delivered is short and brief, e.g., only the WiFi Wallet User Token and the Merchant Token are allowed, and only in a session long enough to acknowledge good receipt.

Each new combination of a WiFi Wallet User Token and a Merchant Token is perishable. Fraud tests are preferably made on the combinations by the issuer 212 to see if a shopping visit by this cardholder at this merchant location makes sense and raises no red flags. Such a visit may be out-of-character for this cardholder, or be physically impossible for the cardholder to be there. It also may not make common sense for a number of reasons.

WiFi Wallet User Tokens 220 are not deliberately publicly displayed or otherwise published in-the-wild. The tokens should be kept private to the user, and the merchant the user is visiting at that moment.

Even so, any interception of a WiFi Wallet User Token 220 in-the-wild is not a problem. One, because fraudsters are limited to working their frauds on the particular merchant POS terminal described by the Merchant Token, and two, every WiFi Wallet User Token 220 have a short time windows of validity. Even more important, Fraudsters can't even get in the secure back channel to participate in the transaction authentication. Fraudsters will be deprived of payment card details because these details are never floated.

If the issuer 212 determines the combination of this WiFi Wallet User Token with this Merchant Token at this time is legitimate, the issuer sends both the mobile client and the merchant's POS a WiFi Wallet Shopping Token 220. Each receive such over secure, back channels. (But grabbing one of these doesn't get a Fraudster anything, they are one-place, one-time, one-merchant, one-cardholder use.) For the mobile client this secure backchannel would be the GSM/GPRS mobile Telco 140 and can include 4G and LTE high speed data channels.

The WiFi Wallet User Token 220 is used privately by the WiFi Wallet mobile client and selected merchant to recognize one another, but only if they intend to complete a checkout.

If no purchase is intended, the WiFi Wallet mobile client simply walks away without ever revealing their WiFi Wallet Shopping Token 220. The WiFi Wallet Shopping Token 220 will expire on its own in ten minutes, or immediately if the WiFi Wallet mobile client 102 logs into in another wireless access point 112, 114, 116, 402, 404, 406.

Even deep into the transaction, no payment card data has left the issuer, nor has the cardholder or merchant ever been equipped to lose such.

Both loyalty programs and exclusion barriers are possible.

It may prove to be of some use to WiFi Wallet mobile clients to be able to exclude whole classes of merchants or locations. The issuer would be in a position to enforce such by not allowing a WiFi Wallet shopping token to issue. Similarly, merchants may want to exclude particular groups of shoppers according to demographics only the issuer would be equipped to deal with.

Payment card merchants benefit from being able to select high quality card readers and point of sale (POS) terminals from hundreds of suppliers around the world. Many are fully supported by service organizations that can function as merchant acquirers and settle payment card accounts with the issuing banks. Their various offerings vary in their details, but agree in their general functions and use.

Big changes are coming soon in the payments industry. One of them is American merchants are going to have to start accepting PIN and chip type payment cards like are widely used in Europe. These cards include a smartchip that must be read with a contact type reader, and they require the cardholder to enter a PIN.

May suppliers like Hypercom (Equinox), Verifone, First Data, Eclipse, and others are already marketing products that have PIN pads and can take plug-in type “EMV” smartcards and slide-and-swipe magnetic stripe cards. Various models are able to communication with V.34 modems on plain-old-telephone-service (POTS) landlines, Ethernet LAN, wireless 802.11 WiFi, and even GSM/GPRS mobile telephone networks. One of these is all a small business needs in order to accept card present (CP) and card-not-present (CNP) transactions. See FIGS. 3A and 3B.

Very small, micro-merchants may not have a wireless access point that could support a roaming WiFi Wallet app and mobile client, e.g., FIG. 1C. Some of these small, micro-merchants may be in remote locations that do not have mobile telephone network coverage 222. The small, micro-merchants in both cases may be relying solely on a POTS landline.

Merchants who are equipped with wireless access points and operate within mobile telephone network coverage 222 can accept WiFi Wallet payments, need a little bit of training as is outlined above in connection with FIGS. 3A and 3B.

Almost universally, these types of card reader terminals will accept a manual entry of card data when the card is present but the magnetic stripe on it is not readable. (Such occurrences are patently suspicious.) WiFi Wallet embodiments can take advantage of this mode to allow the merchant to enter the WiFi Wallet Shopping Token 220.

Cardholders as a group have very wide boundaries imposed on them by the issuing banks. For example, just about any kind of charge, from any kind of place, for any kind of thing, from any country in the world has been acceptable and cleared through merchant acquirers. The only meaningful boundary that was initially imposed was the credit line, and then daily spending limits.

Card issuers are doing better now by contacting cardholders after-the-fact about charges that looked suspicious to them.

Embodiments of the present invention can go farther than this by tracking the behavior of individual cardholders and merchants. What is normal behavior for one individual cardholder may not be normal for another individual cardholder, but still nevertheless be well within the loose boundaries set by issuers for all their cardholders.

Ordinarily collecting enough data to describe the behavior of every cardholder and every merchant from every transaction they've engaged in during their lifetimes with the payment system would be an impossible data storage and processing burden.

Fraud detection embodiments of the present invention reduce the data storage requirements by over a thousand fold by first reducing the details found in a transaction report into a profile. For example, reducing complete addresses into a simple zipcode, reducing stock keeping units (SKU) or prose descriptions into general merchandize categories, reducing exact dollar amounts into ranges, etc.

Each accepted transaction profile arriving in real time is used to update a corresponding real time user profile belonging to particular cardholders and merchants. Over time, many such updates will sharpen and cleanly define the “normal” behavior of each particular cardholders and merchants. Three types of profiling must be maintained for each particular cardholder and merchant: real time, long term, and recursive.

Cardholders and merchants are not completely unique. They will express behaviors that tend to match at least some other cardholders and merchants. Identifying these similar behaviors and placing them in groups can be helpful in detecting fraud when an investigation is launched because a transaction seems to be out of character.

The purchase of some items can be flagged because of their high dollar amount, or because the kind of thing that was never purchased before. These can still nevertheless be normal and should not trigger an alert that will prove later to be a false positive. For example, a long-term profile may reveal it is within character for this cardholder to purchase a $5000 airline ticket every July to Ukraine. But if that same cardholder was seen charging $4500 to Sleep Train (a bedding company), it may be only evident in a grouping of such cardholders that an expense like this for a good mattress is normal for each every ten years. Such would require recursive profiling to discover.

WiFi Wallet embodiments of the present invention have the opportunity to engage in this type of behavioral fraud detection at the point illustrated by FIG. 2E. Issuing bank, here MasterCard 212, would run such checks when the authorization request 238 is received from the merchant.

The discussion that follows in connection with FIGS. 3A and 3B deals with the situation where the merchant has just a bare minimum of POS and card reader equipment. A situation in which alphabetical character entry is impossible and shopper tokens cannot be displayed on a touchscreen. WiFi Wallet shopper token 220 (FIGS. 2A-2F) must be a four-digit number.

FIG. 3A shows the display 300 that will occur on WiFi Wallet mobile client 202 when a four-digit number 302 is used for WiFi Wallet shopper token 220. The purpose is to allow a merchant to use a magnetic card reader's keypad to enter the 16-digit PAN, expiry, and total purchase amounts. All magnetic card readers have a keypad as a backup when there is a problem swiping the magnetic stripe. If you have the numbers available, the actual presence of the card is unnecessary. In order to simplify that entry, a few simple algorithms are used.

In FIG. 3B, if a card-present (CP) merchant 304 is involved, the cardholder with the WiFi Wallet mobile client 202 speaks four-digit number 302 as WiFi Wallet shopper token 220. That number is repeated four times in a string at the magnetic card reader keyboard as if it was a 16-digit PAN read off a magnetic stripe card. The expiry is entered as the current month. The amount to charge is a conventional entry. Otherwise, if a card-not-present (CNP) merchant 306 is involved, the cardholder with the WiFi Wallet mobile client 202 types into a web-form the four-digit number 302 as WiFi Wallet shopper token 220.

At the merchant acquirer, a filter comprising steps 308-313 is added to an otherwise completely conventional authorization request and clearing process. A step 308 looks to see if then PAN is a repeat of four 4-digit groups. If not, the process skips on to conventional authorization request and clearing processing. Otherwise, a step assumes a WiFi Wallet has been used at a merchant with only a magnetic card reader, and checks to see if the expiry is the current month. If not, the request is killed as bogus. A step 310 uses the 4-digit as a WiFi Wallet Shopping Token™ 220. A step 311 checks to see if this WiFi Wallet Shopping Token™ 220 is fresh. If not, the request is killed as bogus. A step 312 checks to see if the merchant making the authorization request is associated with this WiFi Wallet Shopping Token™ 220. If not, the request is killed as bogus. A step 313 fetches the cardholder's real account numbers, etc. and passes them on to the merchant acquirer for conventional authorization request and clearing processing.

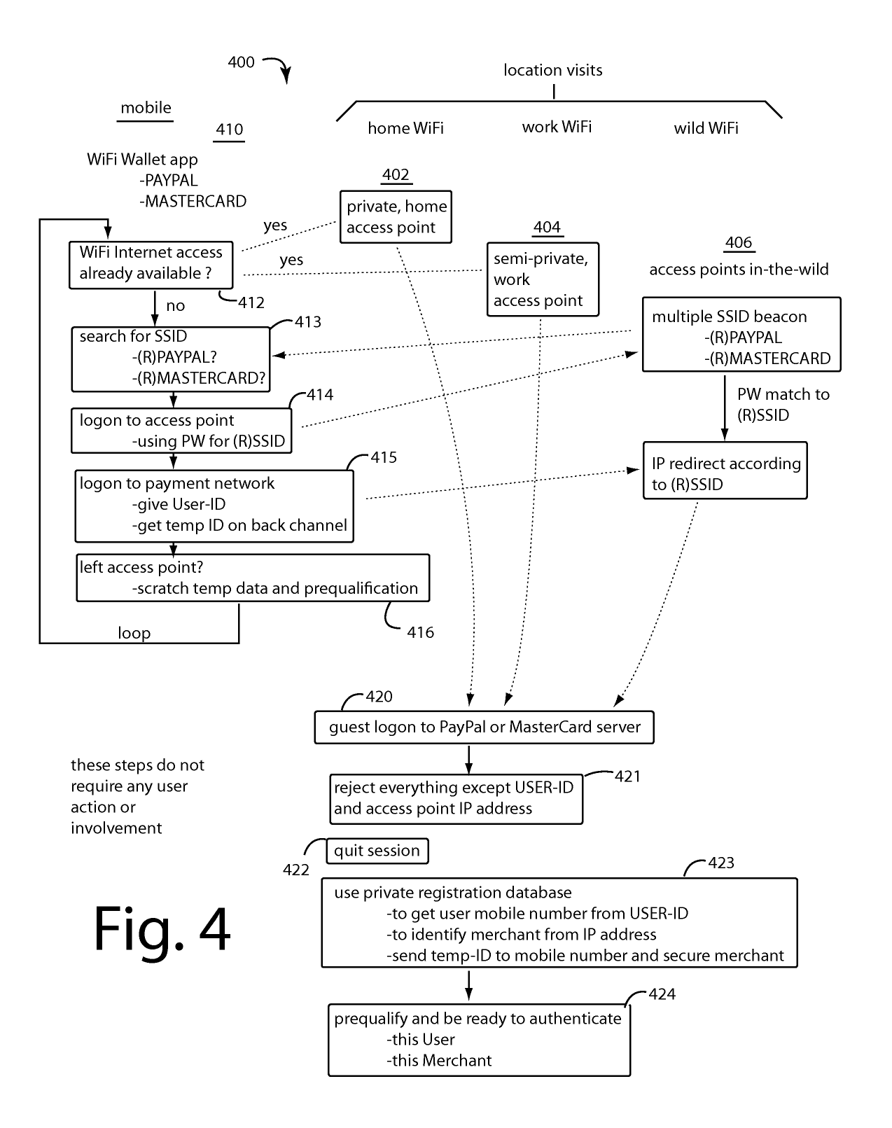

FIG. 4 represents a WiFi Wallet operational flow 400 in which ®PAYPAL and ®MASTERCARD are choices available in type (R)SSID beacon broadcasts at a home WiFi 402, a work WiFi 404, or any in-the-wild WiFi 406. A WiFi Wallet mobile device 410 executes an app with a simple sequence 412-416. A connection manager step 412 sees if any WiFi access point 402, 404, 406 is available. If one's home WiFi access point 402 or work WiFi access point 404 is available, it connects using private credentials.

Otherwise, a step 413 looks for type (R)SSID beacons offering guest network connections. If more than one type (R)SSID is available, WiFi Wallet mobile device 410 picks the one it prefers. A step 414 choses an appropriate password for the (R)SSID it chose, and logs on with it. A step 415 then has Internet access and WiFi Wallet mobile device 410 is able to logon to a corresponding payment network to deliver its user ID and to allow the payment network to collect the merchants' location ID. A step 416 watches to be sure the WiFi Wallet mobile device 410 hasn't wandered off without acting on any purchases. If it has, then any WiFi Wallet Shopping Token™ or temporary shopper ID should be disabled and recycled.

From the point-of-view of the payment network accessed via the wireless access point, a step 420 allows a logon. A step 421 strictly limits the session with the WiFi Wallet to the depositing of an identifying token. Both the payment network and the wireless access point can and should drop the connection, e.g., to allow others on and to throttle any attempts to manipulate the system. A step 423 at the payment network, especially the card issuer, consults its private WiFi Wallet registration database to see which cardholder relates to the identifying token that was deposited. The merchant is also identified by the IP address of the wireless access point that allowed the connection. A WiFi Wallet Shopping Token™ is sent to the WiFi Wallet mobile device and the merchant. A step 424 prequalifies both.

When MasterCard sends a WiFi Wallet Shopping Token™ to the MasterCard cardholder's mobile device via secure message on the mobile network, it gets announced, e.g.,

“We Announced your arrival at COSTCO #0078

just now as “MasterCard Customer ZEQ”

MasterCard sends the same WiFi Wallet Shopping Token™ to the MasterCard merchant via secure financial network, e.g.,

“Our MasterCard Customer ZEQ
has arrived at COSTCO #0078”

If the MasterCard subscriber thereafter leaves the local WiFi area for more than a few minutes, that particular WiFi Wallet Shopping Token™ is scrubbed and recycled.

The mobile device and merchant never handle or store the true identity of the cardholder or any other sensitive information. They really don't need to.

Any available local WiFi is briefly used to upload “Here-I-am” and “where-I-am” notices automatically from randomly visited wireless access points. For security, all confirmations and authentications are messaged on secure back channels using the mobile network and mobile contact numbers previously registered by the MasterCard subscribers. A man-in-the middle attack isn't possible.

To make a purchase, the shopper presents the items they intend to buy, and their WiFi Wallet Shopping Token™, to the MasterCard merchant checkout. (Online or at a retail store.)

“I am MasterCard Customer ZEQ”

The merchant uploads this and the purchase information, charge total, and other details on their preexisting secure channel to MasterCard. Pretty much in the conventional way that is done already, e.g.,

“MasterCard Customer ZEQ wants to charge $123.34

for groceries at COSTCO #0778”

MasterCard asks the cardholder for authentication and approval from the mobile client by collecting a password, e.g.,

“ZEQ: COSTCO #0778 is requesting payment of $123.34 for

groceries. If you approve, enter your password now.”

MasterCard clears payment, and the Merchant releases the Purchase, with a message to the POS, e.g.,

“COSTCO #0778: payment of $123.34 for

groceries by ZEQ is approved.”

Each WiFi Wallet app directs its mobile client's connection manager to find local wireless hotspots it has privileged, secure access to, or that are broadcasting beacons with (R)SSID formed service set identifiers (SSID). The local wireless access point environments home and work would typically provide secure, privileged access to the Internet. The SSID's and passwords to use at a home wireless router or job wireless router would preexist and be independent of WiFi Wallet.

Those sign on as guest networks. WiFi Wallet signs on automatically to each without demanding your attention or putting you at risk. You're always ready to announce you're ready for checkout, and you are pre-qualified to just give the merchant a short confirmation number.

Brand name promotion, recognition, and loyalty return to payments solutions in retail commerce in the electronic, wireless world of hotspot SSID's.

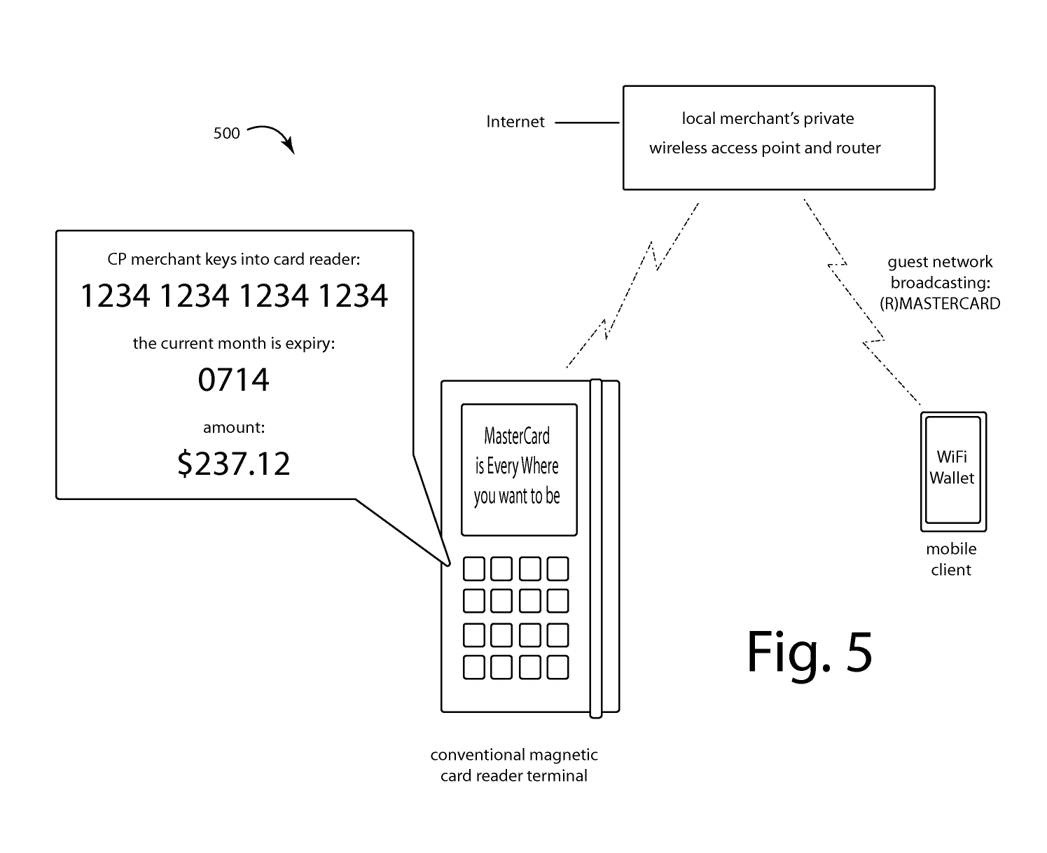

Referring now to FIG. 5, WiFi Wallet Shopping Token™, is an easy-to-speak 4-digit token that a merchant can repeat four times into a conventional magnetic card reader as the PAN.
An ISO/IEC 7812 card number is most commonly 16 digits in length,^{[1]} and can be to 19 digits. The structure is as follows:
a six-digit Issuer Identification Number (IIN) (previously called the “Bank Identification Number” (BIN)) the first digit of which is the Major Industry Identifier (MII),
a variable length (up to 12 digits) individual account identifier,
a single check digit calculated using the Luhn algorithm.^{[2]}

The typical wireless access point is far too difficult to setup. They all come with instructions, but those seem to be written exclusively for experienced network technicians who understand all the jargon, acronyms, trade-offs and terminology. The average American is quite disadvantaged by it all.

It is therefore critical that the WiFi Wallet app or its sister apps include an access point setup wizard that allows users at home/work/retail to setup their wireless access points to support options to suit WiFi Wallet operation, e.g., multiple SSID broadcast beacons, IP redirect, and public payment network passwords.

In-the-wild, at retail locations, WiFi Wallet support can be immediately implemented by just adding a simple, basic WiFi router near the checkout area that broadcasts a preferred payment network in its beacon, e.g., ®MASTERCARD or ®MASTERCARD.

The SSID is a unique identifier that wireless networking devices use to establish and maintain wireless connectivity.

Multiple access points on a network or sub-network can use the same SSID's. SSID's are case sensitive and can include up to thirty-two alphanumeric characters. Do not include spaces in your SSID's.

Cisco 1200 series access points can be configured with up to sixteen SSID's. Each SSID can be assigned different configuration settings. All the SSID's are active at the same time. Client devices can associate to an access point using any of the SSID's.

The settings that can be assigned to each SSID are VLAN, Client authentication method, Maximum number of client associations using the SSID, Proxy mobile IP, RADIUS accounting for traffic using the SSID, Guest mode, and Repeater mode, including authentication username and password

The access point can allow associations from client devices that do not specify an SSID in their configurations, e.g., a guest SSID. The access point includes the guest SSID in its beacon. The access point's default SSID, tsunami, is set to guest mode. However, to keep a network secure, the guest mode SSID should be disabled on most access points.

If your access point will be a repeater or will be a root access point that acts as a parent for a repeater, you can set up an SSID for use in repeater mode. You can assign an authentication username and password to the repeater-mode SSID to allow the repeater to authenticate to your network like a client device. If your network uses VLANs, you can assign one SSID to a VLAN, and client devices using the SSID are grouped in that VLAN.

An exemplary setup on a ASUS RT-AC68U Gigabit Router added three guest networks to an already installed and functioning system.

| | | | |
|---|---|---|---|
| Network | (R)MASTERCARD | (R)VISA | (R)PAYPAL |
| Name(SSID) | | | |
| Authentica- | WPA2-Personal | WPA2- | WPA2-Personal |
| tion | | Personal | |
| Method | | | |
| Network | MCPassword | VISAPassword | PAYPALPassword |
| Key | | | |
| Time | Limitless | Limitless | Limitless |
| Remaining | | | |
| Access | off | off | off |
| Intranet | | | |

The WiFi Wallet app searches for these and other (R)SSID's, as we'll refer to them here. The (R)SSID's we choose to enable here are: “®MASTERCARD”, “®VISA”, and “®PAYPAL”. These will appear as broadcasts in the local WiFi router's beacon. Each requires a WPA2-Personal AES network key for logon, respectively: “MCPassword”, “VISAPassword”, and “PAYPALPassword”.

As a WiFi Wallet moves from one WiFi router to another at home/work/retail, its Connection Manager needs to know or have a way of predicting the exact form of (R)SSID that exists for the preferred payment networks. The same is true for the respective passwords. The simplest thing to do is use the same (R)SSID's and associated passwords everywhere for all installations. In the long run, that may not prove to be practical or secure enough.

It is imperative, however, that the WiFi Wallet connection manager be able to automatically logon to the local WiFi router without user invention or annoyance to them. There should be no adverse consequences of their passive permission for their WiFi Wallet Connection Manager to do so, and the user should not be made personally identifiable by such until the user presents themselves as a purchaser and provides the temp-ID they were sent on the secure back channel.

Any local WiFi routers that do not want random, anonymous guest network logons from WiFi Wallet apps and users should not use any of the (R)SSID names. It may be advantageous for the payment network providers who each respectively own a federal trademark registration to have legislation passed that recognizes the use of (R)SSID broadcasts in WiFi access point beacons as an exclusive and protected right of the trademark owner.

The WiFi Wallet app carries the URL web address of its payment network provider that they want used as visitor logon, e.g., where on the Internet user ID and router IP addresses can be sent for prequalification and issuance of a temp-ID.

Higher end WiFi routers have an IP Redirect mode in which the router can control who the client can connect with. WiFi Wallet applications do not need to all an (R)SSID client to connect with any other that the respective payment network, and only long enough to trigger prequalification of the user and the issuance of a temp-ID.

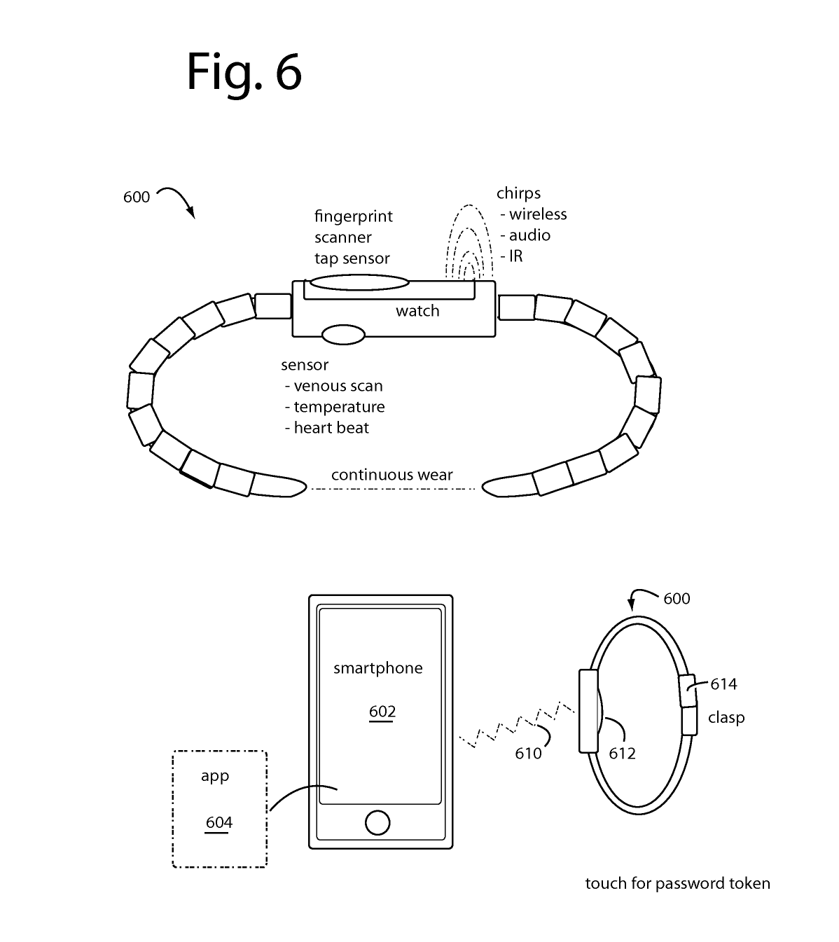

FIG. 6 represents a wrist-worn authenticator embodiment of the present invention, and is referred to herein by the general reference numeral 600. In operation, wrist-worn authenticator 600 “chirps” out a message for a point-of-sale device, but only when the user makes some deliberate action. For example, an encrypted authentication burst packet is launched when wrist-worn authenticator 600 is tapped by a finger on the other hand. The chirps can be variously output as sound, optical, or radio frequency, e.g., audio chirps, IR-LED chirps, and/or wireless chirps. All of which can be sensed by conventional smartphones and tablets.

Not allowing transmissions until a deliberate tap is detected will also conserve battery life.

The chirps are encrypted with device-ID, GPS location, local time, and user biometrics. A display normally shows the user the time-of-day, and will further visually annunciate any local authentication requests it senses. It could also display commercial messages, warnings, and reminders based on time, place, circumstances, events, and environment.

The wrist-worn authenticator 600 collects biometric data available to it only by direct contact with the user. The data collected is passed on by embedding it in the chirps. In one embodiment, no attempt is made to locally authenticate the collected biometrics to the present user.

User authentication occurs in the Cloud, with further qualifications of time, place, device-ID, user behavior, and registration constraints.

The human bodies of users present unique fingerprint patterns, unique venous patterns in the wrist, voice, and even highly characteristic heart beat patterns that can be used to identify a particular user from millions of users. Direct contact biometric data collection includes pulse, venous patterns, fingerprint, gestures, continuous wear, and temperature. Strong multi-factor authentications combine from who-you-are, what-you-have, what-you-say, where-you-are, how-you-behave, and what-time-it-is.

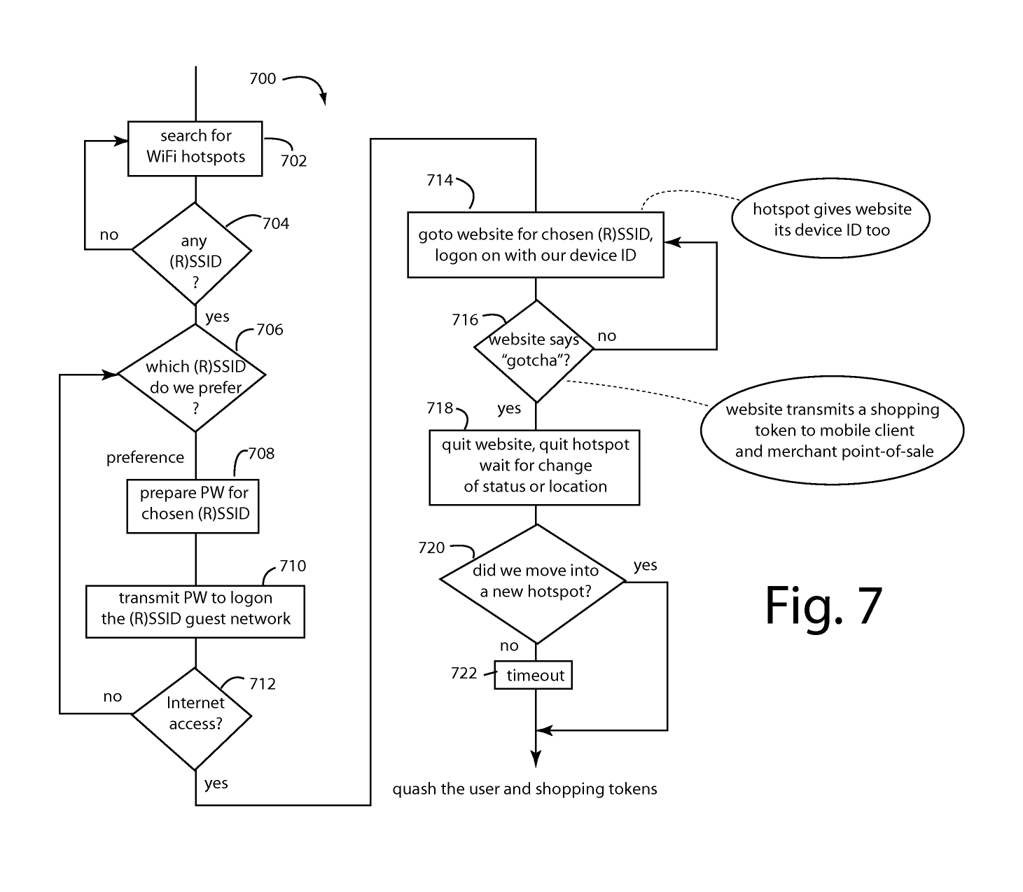

FIG. 7 represents one starting piece of the program software flow for a typical WiFi Wallet app. A connection manager 700 begins with a search for any wireless routers broadcasting service set identifier (SSID) beacons within range in a step 702. A step 704 asks if any such SSID beacons are type (R)SSID, e.g., ®MASTERCARD, ®VISA, ®PAYPAL. If so, a step 706 consults a preference list to see which of the type (R)SSID broadcasts we should connect to first. A step 708 fetches a universal password from memory that should be good around the world when attempting to connect to a particular payment networks (R)SSID. A step 710 transmits that password to logon, e.g., as a guest to a guest network that offers limited Internet access and capabilities to its guests. A step 712 asks if we succeeded in getting Internet access.

If so, a step 714 uses a URL web address it has stored in memory for the particular payment network that we preferred. We logon to such website with a user token that connection manager 700 was given when the WiFi Wallet app installed. A step 716 sees if we succeeded in the payment network logon. If so, the payment network website should have captured our user token and a merchant location token and succeeded in looking up both to see really who the cardholder and merchant are and various tests for fraud.

If all looks good, the website acknowledges a good logon and issues a WiFi Wallet Shopping Token to both the merchant and the user. WiFi Wallet Shopping Tokens have only a brief life, and are only good at the particular merchant location that corresponds to the merchant location token used originally. They are also good one-time-only and subject to many fraud checks by the issuer and acquirer.

A step 718 quits the session, at the WiFi Wallet app, with the wireless access point, and with the payment network website. Conventional wireless access points may not be able to do that, and may need some modifications. A step 720 idles checking to see if the local wireless SSID broadcasts have changed, indicating the WiFi Watt has moved on to a new venue. If so, or after a timeout 722, the user token at this wireless access point location and any shopping token we may have acquired are quashed.

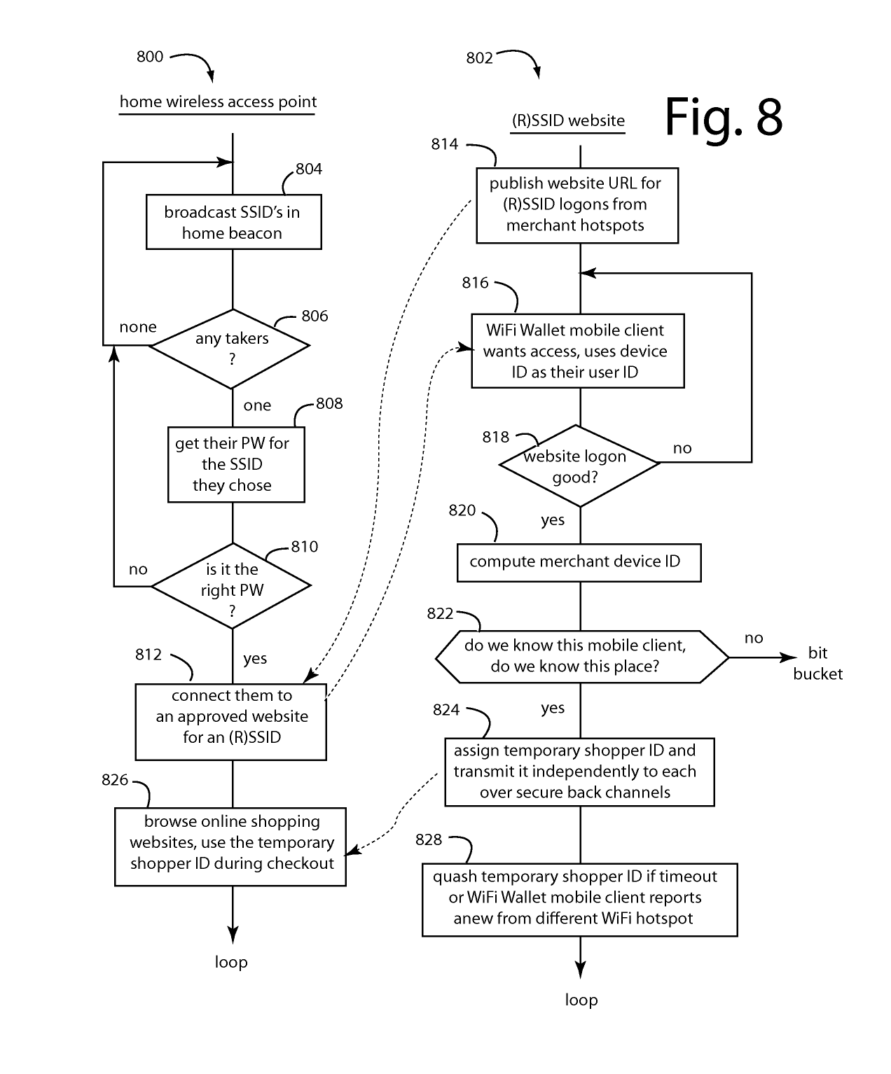

FIG. 8 represents the runtime software interplay between a home wireless access point 800 and a payment network's (R)SSID website 802. A step 804 broadcasts at least one SSID in a beacon from a home wireless access point 800. A step 806 looks for any WiFi equipped mobile client takers. A step 808 requests the password for the SSID. A 810 step checks if the password was right. If so, Internet access is granted. A step 812 allows the mobile client to connect to any payment network's published website using a URL web address 814 already provisioned with WiFi Wallet app. A step 816 recognizes the mobile client wants access, e.g., to obtain a shopping token.

A step 818 looks to see if the logon succeeded. If so, a step 820 computes the merchant device or location ID from a token. A step 822 vets this token to see if it is registered with us. If yes, a step 824 assigns a WiFi Wallet Shopping Token. A step 826 allows the user with the WiFi Wallet mobile client to browse online shopping sites and to use the issued WiFi Wallet Shopping Token at any subsequent checkout. A step 828 quashes the tokens immediately after they served their purposes.

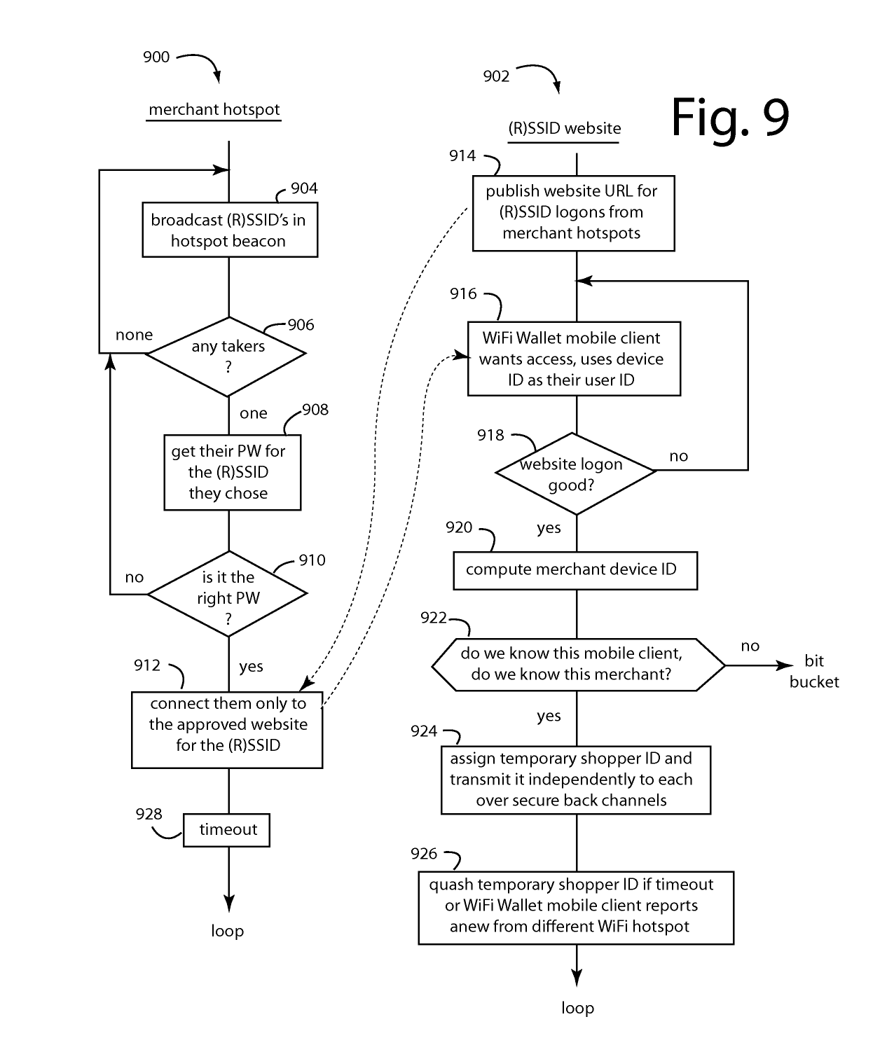

FIG. 9 represents the runtime software interplay between a merchant's wireless access point 900 and a payment network's (R)SSID website 902. A step 904 broadcasts at least one type (R)SSID in a beacon from a merchant wireless access point 900. A step 906 looks for any WiFi equipped mobile client takers. A step 908 requests the password for the (R)SSID. A 910 step checks if the password was right. If so, limited Internet access is granted. A step 912 allows the mobile client to connect to only the payment network's published website using a URL web address 914 already provisioned with WiFi Wallet. A step 916 recognizes the mobile client wants access, e.g., to obtain a shopping token.

A step 918 looks to see if the logon succeeded. If so, a step 920 computes the merchant device or location ID from a token. A step 922 vets this token to see if it is registered with the payment network. If yes, a step 924 assigns a WiFi Wallet Shopping Token. A step 926 quashes the tokens immediately after they served their purposes. A timeout 928 has the same effect.

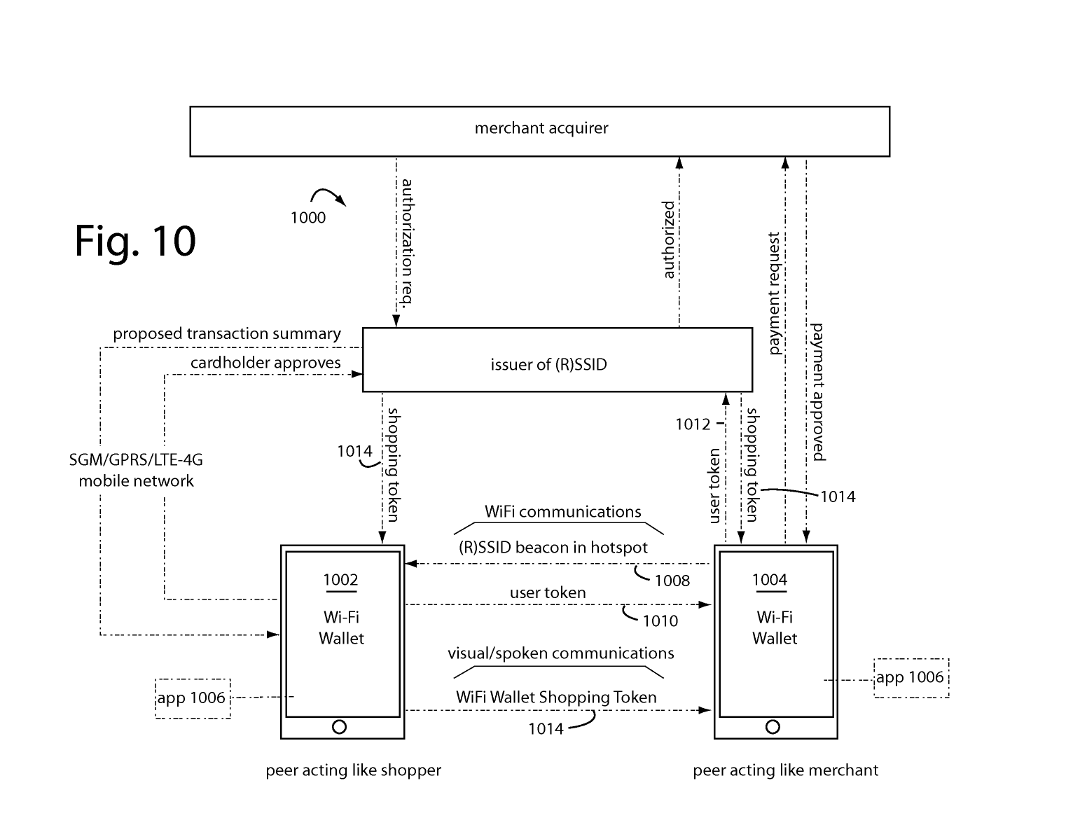

FIG. 10 represents a WiFi Wallet Peer-to-Peer (P2P) application 1000. Identical mobile devices 1002 and 1004 are provisioned with a WiFi Wallet app 1026. Each mobile device 1002 and 1004 is capable of generating its own wireless “hotspot”, but we show here in FIG. 10 only mobile device 1004 doing that. It generates a type (R)SSID beacon 1008 identical to 205 (FIG. 2A and 2B), 804 (FIGS. 8), and 904 (FIG. 9).

When mobile device 1002 sees (R)SSID beacon 1008 it will respond with a user token 1010. So, mobile device 1002 acts as a shopper and mobile device 1004 acts as a merchant. Their respective roles are easily reversed. The interplay between them proceeds like that described earlier, and especially in connection with FIGS. 7-9.

Three kinds of communications are used, WiFi, mobile network, and visual/spoken. User and shopping tokens 1012 and 1014 are safe to expose on the WiFi networks or visually in the presence of snoopers and eavesdroppers. Authorization and authentication traffic is best encrypted and reserved to the mobile network.

A barcode scanner app included on mobile device 1004 would allow it to do fast shopping cart checkouts by optically reading the SKU's of items being purchased.

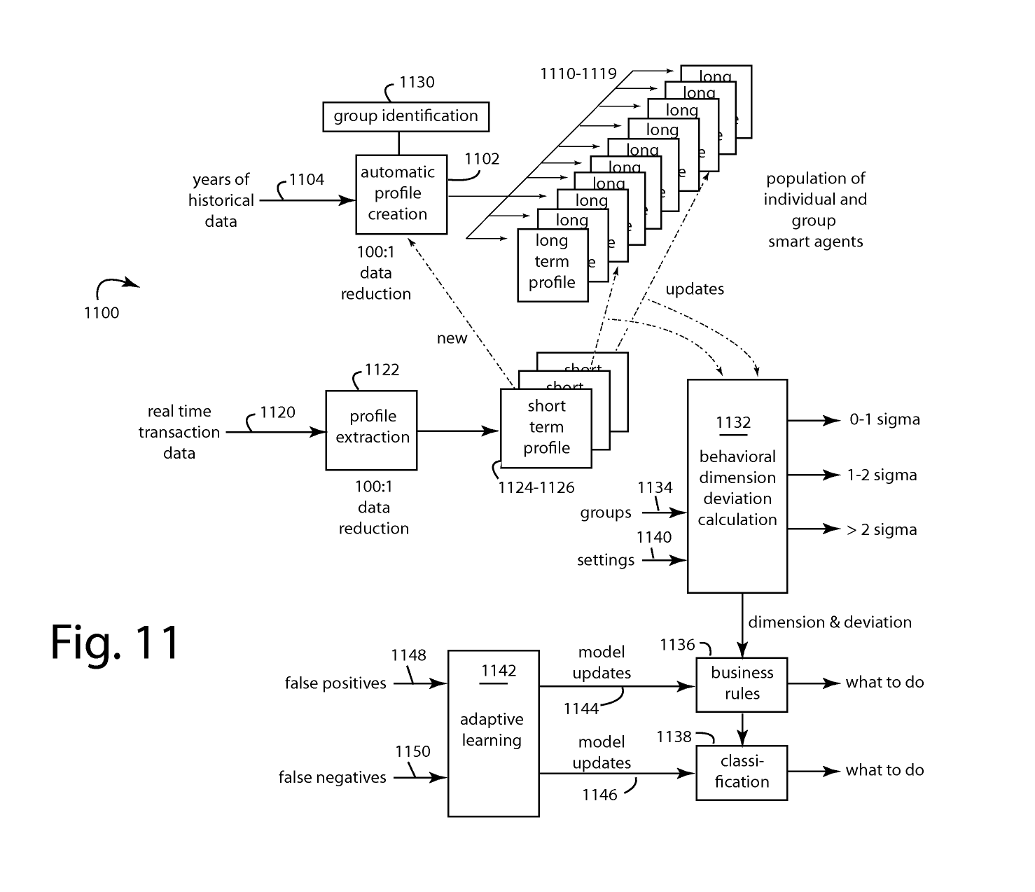

FIG. 11 represents a smart-agent based adaptive method for mobile payments fraud detection, and is referred to herein by the general reference numeral 1100. Method 1100 includes a step 1102 for automatic profile creation. A historical data feed 1104 of supervised learning data is sorted and searched to identify individual cardholders 1110-1119 using data mining techniques. A typical application will involve two years' worth of historical data 1104 provided from millions of cardholders represented in long term profiles 1110-1119. Such historical data 1104 could easily amount to twenty-seven terabytes of information, making it impractical to store here.

Embodiments of the present invention distill historical data 1104 and real-time payments data 1120 into behavioral profiles for as much as a 100:1 compression. A profile extraction step 1122 operates on incoming real-time payments data 1120 to build short-term profiles 1124-1126. Some of these short-term profiles 1124-1126 will be new, not having appeared in the historical data 1104, and will be forwarded to automatic profile creation step 1102. Others will have matches already existing in the population of individual cardholder 1110-1119.

Particular behavioral dimensions in long-term profiles 1110-1119 will match those in others. Such clustering can be used to judge if an unusual behavior for an individual is nevertheless normal for members of their group.

A group identification step 1130 will collect these matching long-term profiles 1110-1119 and generate a group profile. These group profiles are added to the population of long-term profiles 1110-1119. For example, particular cardholders can share service locations, staffing practices, claim types, billing levels, etc. These commonalities would compel certain behaviors in all of the members, if only occasionally.

Short-term profiles 1124-1126 are used dimension-by-dimension to update the behaviors being tracked and followed by long-term profiles 1110-1119. Updates that deviate less than one sigma from that already stored as normal behavior will cause little of no concern.

A deviation calculation step 1132 can also indicate updates that deviate more than one sigma but less than two sigma from that already stored as normal behavior. Such indicates marginal confidence of normal, non-fraudulent behavior, but needs further analysis and input from group profiles 1134, business rules 1136, or model classifiers 1138. A settings input 1140 can be used to change the confidence level thresholds.

Deviation calculation step 1132 can also indicate updates that deviate more than two sigma from that already stored as normal behavior. Such indicates fraudulent behavior and requires the attention of auditors or law enforcement. The business rules 1136 are adjusted to output commands on what-to-do in each case.

An adaptive learning step 1142 computes the model updates 1144 and 1146 that are necessitated by false positives 1148 and false negatives 1150 to business rules 1136 and classification models 1138. Such classification models 1138 include decision trees, neural networks, and genetic algorithms.

Each profile includes constituent behavioral dimensions that correspond to some significant aspect of the claim or transaction data that reflects the way the particular cardholder bills or provides services. These behavioral dimensions are carefully chosen to include only behavioral measures that correlate to fraud. Irrelevant details and categories can be skipped over. All profiles are provisioned with the same sets of behavioral dimensions so they can be consistently compared to one another.

In some embodiments of the present invention, each behavioral dimension is a single value representing the running average of all the training data and all the updates for that aspect of that smart agent profile. All the preceding individual data points and updates that contributed are disposed of, rather than retained after they have been used to calculate the rolling average. The memory demands of such a system would be very practical, e.g., a gigabyte to track one million smart agent profiles.

A rolling weighted average could also be used to give favor to the more recent updates, for example. A time series can be used to smooth out short term fluctuations. Simple moving averages, cumulative moving averages, weighted moving averages, exponential moving averages can be mixed amongst different aspects, depending on experience with false positives and false negatives.

In summary, embodiments of the present invention excel in fraud detection in hundreds of very different industry applications because millions of smart agent profiles can be spawned to track millions of targets. Each smart agent profile adapts itself to its corresponding target, learning and changing over time independently of all the others. Tighter controls can be used because the controls are customizable, not one-size-fits-all.

WiFi Wallet will allow many different facilities to be accessed with the same device. For businesses, moving the security badge and access into a mobile device reduces costs and increase the security as the system can monitor in real-time the accesses and can be used to manage the attendance and trigger an alarm if a high security place is not protected.

The security issues facing the Aviation industry are both specific and demanding. Wifi Wallet will provide an access control solution as well as way of being certain that at any time no pilot can for example be in the cockpit by himself. WiFi Wallet can also be used to assign specific pieces of equipment to specific employees for a specific time.

It can also be used to secure facilities from unwanted visitors as well as managing access levels. Special types of access control can be programmed during a window-of-time. With WIFI technology it is possible to reprogram access rights, add new users without physically delivering a card, make changes to remote client access without having to reprogram the door controllers or cards, cancel access for lost devices and reactivate them if they are found. For example, financial institutions can monitor high risk areas, customer and staff safety and manage restricted access. With the move to reducing physical barriers in branches, Wifi Wallet can trigger an alert if unauthorized person is trying to gain access to restricted areas.

Using a Wifi Wallet enrollment and authentication system, government employees will not need multiple cards to access multiple sites. This one access to specific areas can be programmed for the hours where the employee is supposed to be in any facility. In the case of an emergency Wifi Wallet can lock down or open all doors as per the crisis level activated. In Transportation, the size of the industry leads to challenges in both the range of vulnerabilities and the volume of passengers and freight to be protected, creating a need for systems that can be scaled to meet requirements. Wifi Wallet will allow users to detect, monitor and respond to events in the most safe and effective way.

Using Wifi Wallet, companies can encrypt files, documents, applications, and keys to secure access. Company servers can be secured by limiting specific tasks to specific peoples during a certain period of time and locking down internal and external accesses to any company system.

Wifi Wallet can also help financial institutions provide precision retail marketing, Wifi Wallet can confirm a mobile phone is in the zip code for the issuer and increase the marketing accuracy.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. A secure access system for users with mobile devices, comprising:
a mobile app data structure for installation in a user mobile device with a wireless local area network connection manager and mobile telephone network access;
a wireless access point adapted to broadcast a particular SSID that will access a predetermined password from any locally visiting user mobile device;
means for the user mobile device to search for said particular SSID and to automatically supply said predetermined password;
a network server accessible over a network by the wireless access point and the user mobile device once logged onto the wireless access point;
a security barrier physically proximate to the wireless access point, and providing at least one of payment transaction security, computer console log-on security, or physical access security;
means for the network server to independently communicate secure authentication and authorization messages directly with the user mobile device apart from the wireless access point, and with the security barrier; and
means for limiting access for at least one of time, place, purpose, or thing if the network server authenticates the user mobile device and authorizes the security barrier to allow local access.

2. The secure access system for users with mobile devices, further comprising:
means for said wireless access point to broadcast a commercial brand name as an SSID and to accept a particular universal password corresponding to that commercial brand name from any locally visiting user mobile device.

3. The secure access system for users with mobile devices, further comprising:
means for limiting communication between any locally visiting user mobile device to the network server through said wireless access point to no more than the supplying of a user identity token in an encrypted message.

4. The secure access system for users with mobile devices, further comprising:
means for preventing any secure access with a user mobile device that presents locally in two or more wireless access points at the same time or too brief a time from one to the next.

5. A WiFi wallet data structure for wireless authentication of a mobile smartphone carried into a shopping environment by a user, comprising:
means for searching from a mobile smartphone for a local wireless access point broadcasting a particular predefined SSID, a substantially fixed location, and capable of connecting to the Internet;
means for sending from said mobile smartphone to said local wireless access point a particular and corresponding predefined password capable of logging onto said local wireless access point;
means for accessing a particular and corresponding predefined Internet website from said mobile smartphone using said local wireless access point;
means for uniquely identifying said mobile smartphone and said local wireless access point to said Internet website; and
means for quitting any access of said Internet website by said mobile smartphone after attempting to identify itself;
means for limiting any subsequent authentication of said mobile smartphone to a restricted list of authorized merchants based on a unique identification of said local wireless access point, and limiting time for any related financial transactions to be concluded.

6. The WiFi wallet of claim 5, further comprising:
means for restricting any access of said mobile smartphone through said local wireless access point to said Internet website to the communicating of no more than is necessary to uniquely identify said mobile smartphone to said Internet website;
means for immediately quitting any access of said Internet website by said mobile smartphone after attempting to identify itself; and
means for preventing said local wireless access point from being able to provide information about said mobile smartphone after its attempts to identify itself to said website that would be sufficient in themselves to uniquely identify said mobile smartphone or any corresponding particular accountholder.

7. The WiFi wallet of claim 5, further comprising:
means for wirelessly contacting or messaging said mobile smartphone from a third party through a different communications channel not involving any said local wireless access point;
means for formulating any wireless contacts or messages to said mobile smartphone from said third party based on information preregistered to a corresponding particular accountholder;
means for accessing particular information preregistered to said corresponding particular accountholder from information obtained by the means for uniquely identifying said mobile smartphone and said local wireless access point to said Internet website.

8. The WiFi wallet of claim 5, further comprising:
means for contacting or messaging a point-of-sale device associated with and corresponding to said local wireless access point;
means for formulating any contacts or messages to point-of-sale device from a third party based on information preregistered to a corresponding particular merchant;
means for accessing particular information preregistered to corresponding particular point-of-sale device from information obtained by the means for uniquely identifying said mobile smartphone and said local wireless access point to said Internet website.

9. The WiFi wallet of claim 5, further comprising:
means for preregistering and associating said mobile smartphone to a particular accountholder;
means for preregistering and associating said local wireless access point to a particular shopping environment, location, or merchant account;
means for provisioning a plurality of independent mobile smartphones to all search for any local wireless access point broadcasting said particular predefined SSID;
means for provisioning all of said plurality of independent mobile smartphones with said predefined password; and
means for provisioning everyone of a plurality of independent local wireless access points to accept said predefined password.

10. A mobile payments method for automatically enabling a particular mobile wireless device while within radio range of any wireless access point to electronically authorize a payment transaction, comprising:
a step for forwarding a user token provided by a user mobile device through any local wireless access point while within its wireless radio range to a card issuer via a network;
a step for pairing said user token with a single merchant identifier identifiable from a particular wireless access point that actually forwarded said user token to said card issuer;
a step for identifying the validity of a particular cardholder subscribed to said card issuer and user verification by said user token;
a step for identifying the validity of a particular merchant subscribed to said card issuer and previously associated and registered with said particular wireless access point;
a step for computing and encoding a shopping token from said card issuer if both the particular cardholder and the particular merchant are valid;
a step for transmitting said shopping token over separate secure networks to both the mobile user device registered to the particular cardholder and the local point-of-sale terminals registered to said particular merchant;
a step for presenting a shopping cart for checkout and paying for purchases to said particular merchant by said particular cardholder together as enabled by said shopping token;
a step for said particular merchant to select a previously received shopping token they received for matching, and for adding purchase details, and for forwarding a payment request message over the network to the card issuer;
a step for the card issuer to send a transaction summary and user authorization request to said user mobile device via a secure mobile network;
a step for returning from said user mobile device to an approval to card issuer with a summary of what user acknowledges they are approving; and
a step for the card issuer to directly notify said particular merchant over the network that the transaction is approved and the purchases can be released.
